(19) United States
(12) Patent Application Publication
(10) Pub. No.: US 2026/0106386 A1
(43) Pub. Date: Apr. 16, 2026

(54) SHUNT ASSEMBLY SYSTEM AND METHOD

(71) Applicant: Preformed Line Products Company, Cleveland, OH (US)

(72) Inventors: Simon Maier, Dornbirn (AT); Daniel Fetz, Dornbirn (AT); Günther Schuster, Dornbirn (AT); Kevin Ender, Dornbirn (AT)

(21) Appl. No.: 19/357,692

(22) Filed: Oct. 14, 2025

Related U.S. Application Data
(60) Provisional application No. 63/706,816, filed on Oct. 14, 2024.

(51) Int. Cl. H01R 11/01; H01B 1/02; H01R 11/09

(52) U.S. Cl. CPC H01R 11/01; H01B 1/023; H01R 11/09

(57) ABSTRACT

A shunt assembly includes a first coupler and a second coupler offset from each other in a longitudinal direction, and a conductor that is flexible as compared to the first coupler and the second coupler. The conductor includes a first end portion fixed with the first coupler, and includes a second end portion fixed with the second coupler. The first end portion or the second end portion forms a proximal arcuate segment and a distal arcuate segment, the proximal arcuate segment opens in a first direction orthogonal to the longitudinal direction, and the distal arcuate segment opens in a second direction opposite the first direction.

### CROSS-REFERENCE TO RELATED APPLICATIONS

This application claims the benefit of U.S. Provisional Application No. 63/706,816 filed Oct. 14, 2024, which is incorporated herein by reference in their entireties.

### BACKGROUND

High-current substation buswork commonly employs tubular aluminum conductors with typical lengths of, for example, 7-20 meters and diameters of, for example, 80-350 millimeters. These busbars expand and contract with thermal and mechanical changes arising from current load and external conditions, creating relative movement that must be accommodated at connections. In many busbar installations, connectors are fixed to the tubular bus to establish a reliable, low-resistance contact surface capable that transfers high current over extended service intervals. The aging of such connections is closely tied to operating temperature, as elevated temperatures accelerate degradation.

Industry practice emphasizes low and stable contact resistance and adherence to standards that, among other requirements, often call for connector temperatures to remain below busbar temperatures. Achieving low temperature rise often drives the use of large contact areas and conductive elements with substantial cross-sections in a manner that hinders mechanical flexibility between busbar terminals. Conventional arrangements frequently rely on highly flexible conductors, such as SAL aluminum cable, or rely on lamella expansion tapes fixed with the busbar terminals. These geometries are further constrained by a need to avoid corona discharge and to maintain radio influence voltage performance within specified limits.

Persistent challenges remain with these established approaches. In this regard, mechanical and thermal cycling can disturb alignment and clamping pressure at interfaces, influencing contact resistance and temperature stability. Electromagnetic phenomena, including skin and proximity effects, tend to concentrate current toward outer conductor regions, fostering asymmetrical current sharing, localized heating, and accelerated aging that can shorten service life or pressure compliance with temperature-related norms. Further space constraints and electrical clearances in compact substations may complicate conductor routing near bus interfaces and intermediate structures, heightening the risk of crowding, excessive bending, or proximity-induced imbalances.

### BRIEF DESCRIPTION

According to one aspect, a shunt assembly includes a first coupler and a second coupler offset from each other in a longitudinal direction, and a conductor that is flexible as compared to the first coupler and the second coupler. The conductor includes a first end portion fixed with the first coupler, and includes a second end portion fixed with the second coupler. The first end portion or the second end portion forms a proximal arcuate segment and a distal arcuate segment, the proximal arcuate segment opens in a first direction orthogonal to the longitudinal direction, and the distal arcuate segment opens in a second direction opposite the first direction.

According to another aspect, a shunt assembly, includes a first coupler and a second coupler offset from each other in a longitudinal direction. The shunt assembly also includes a conductor that is flexible as compared to the first coupler and the second coupler. The conductor includes a first end portion fixed with the first coupler, includes a second end portion fixed with the second coupler, and forms an arched profile in the first end portion and the second end portion, along the longitudinal direction. The shunt assembly also includes a radiator that is rigid as compared to the conductor, fixed with the conductor along the arched profile, between the first coupler and the second coupler in the longitudinal direction, and includes fins that extend outward from the conductor.

According to another aspect, a shunt assembly includes a first coupler and a second coupler offset from each other in a longitudinal direction, and a plurality of conductors extending between the first coupler and the second coupler. Each of the conductors includes a first end portion fixed with the first coupler and a second end portion fixed with the second coupler. Each of the conductors are fixed with the first coupler or the second coupler in a single row along a normal direction orthogonal to the longitudinal direction, and the conductors are arranged in multiple rows offset from each other in the normal direction, at a location between first coupler and the second coupler in the longitudinal direction.

The innovation described herein describes a shunt assembly for substation busbars that employs a flexible conductor arranged between offset couplers and configured with arcuate segments to form an arched profile, with heat-dissipating radiators positioned along a middle portion of the conductor. In addition to other described features, functions and benefits, the shunt assembly described herein may enable reliable high-current transfer with controlled temperature rise, balanced current sharing, and accommodation of thermal and mechanical movement while maintaining electrical clearances and compliance with performance standards.

### BRIEF DESCRIPTION OF THE DRAWINGS

FIG. 1 is a top perspective view of an example shunt assembly in accordance with aspects of the innovation.

FIG. 2. is a bottom perspective view of the shunt assembly of FIG. 1.

FIG. 3 is a side view of the shunt assembly of FIG. 1.

FIG. 4 is a front view of the shunt assembly of FIG. 1.

FIG. 5 is a top view of the shunt assembly of FIG. 1.

FIG. 6 is a perspective view of a coupler included in the shunt assembly of FIG. 1.

FIG. 7 is a front view of the coupler of FIG. 6.

FIG. 8 is a side view of the coupler of FIG. 6.

FIG. 9 is a top view of the coupler of FIG. 6.

FIG. 10 is a perspective view of a substation system including the shunt assembly of FIG. 1.

FIG. 11 is a front perspective view of the shunt assembly of FIG. 1.

FIG. 12 is a side perspective view of the shunt assembly of FIG. 1.

FIG. 13 is a partial side perspective view of a first radiator and a second radiator included in the shunt assembly of FIG. 1.

FIG. 14 is a top perspective view of a first shell portion included in the first radiator of FIG. 13.

FIG. 15 is a bottom perspective view of the first shell portion of FIG. 14.

FIG. 16 is a top view of the first shell portion of FIG. 14.

FIG. 17 is a bottom view of the first shell portion of FIG. 14.

FIG. 18 is a side view of the first shell portion of FIG. 14.

FIG. 19 is a front view of the first shell portion of FIG. 14.

FIG. 20 is a cross-sectional front view of the first shell portion of FIG. 14.

FIG. 21 is a top perspective view of an insert included in the first radiator of FIG. 13.

FIG. 22 is a top view of the insert of FIG. 21.

FIG. 23 is a side view of the insert of FIG. 21.

FIG. 24 is a front view of the insert of FIG. 21.

FIG. 25 is a heat map of the shunt assembly of FIG. 1.

### DETAILED DESCRIPTION

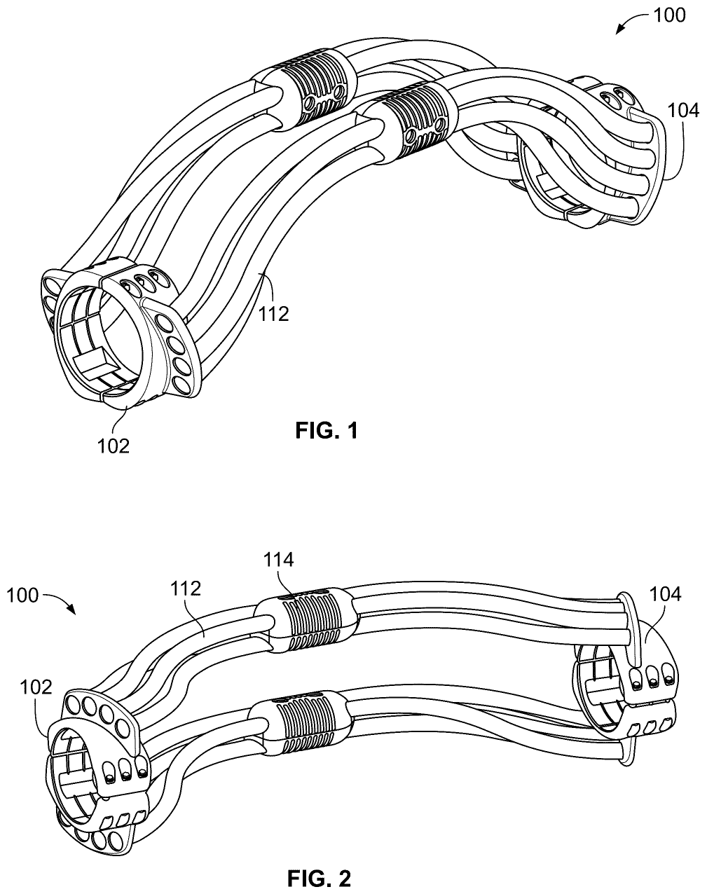

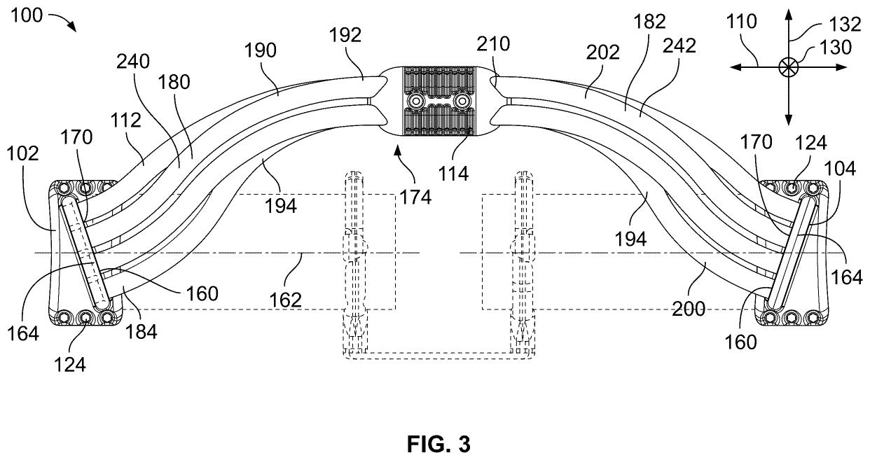

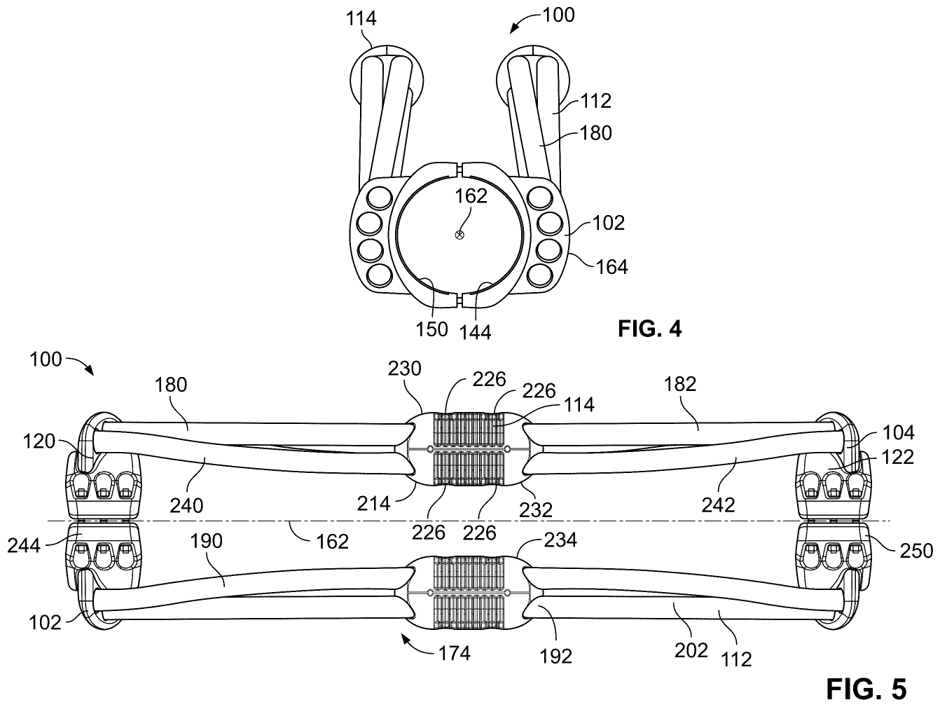

It should, of course, be understood that the description and drawings herein are merely illustrative and that various modifications and changes can be made in the structures disclosed without departing from spirit and scope of the present disclosure. Referring now to the drawings, wherein like numerals refer to like parts throughout the several views, in accordance with an aspect of the innovation, FIG. 1-5 depict a shunt assembly 100 including a first coupler 102, a second coupler 104 offset from the first coupler 102 in a longitudinal direction, indicated by an arrow 110 (see FIG. 3), conductors 112 fixed with the first coupler 102 and the second coupler 104, and radiators 114 fixed with the conductors 112. The conductors 112 are flexible as compared to the first coupler 102, the second coupler 104, and the radiators 114, and elastically deforms when the first coupler 102, the second coupler 104, or the radiators 114 move relative to each other. As such, the shunt assembly 100 flexes under mechanical loading from the first coupler 102 and the second coupler 104, while conducting electrical current between the first coupler 102 and the second coupler 104 and dissipating heat through the radiators 114.

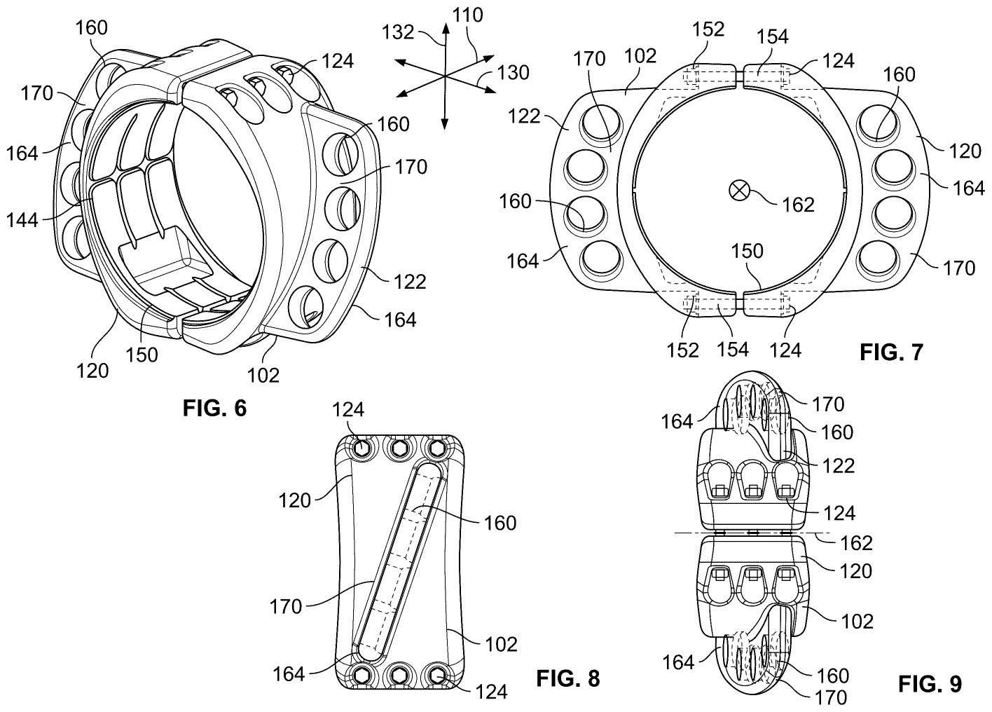

FIG. 6-9 depict the first coupler 102, including a first half 120, a second half 122, and fasteners 124 that drive the first half 120 toward the second half 122 in a lateral direction orthogonal to the longitudinal direction and indicated by an arrow 130. The first coupler 102 is a sleeve clamp, and the fasteners 124 are bolts that fix the first half 120 with the second half 122 in the longitudinal direction, the lateral direction, and a normal direction orthogonal to the longitudinal direction and the lateral direction, the normal direction indicated by an arrow 132.

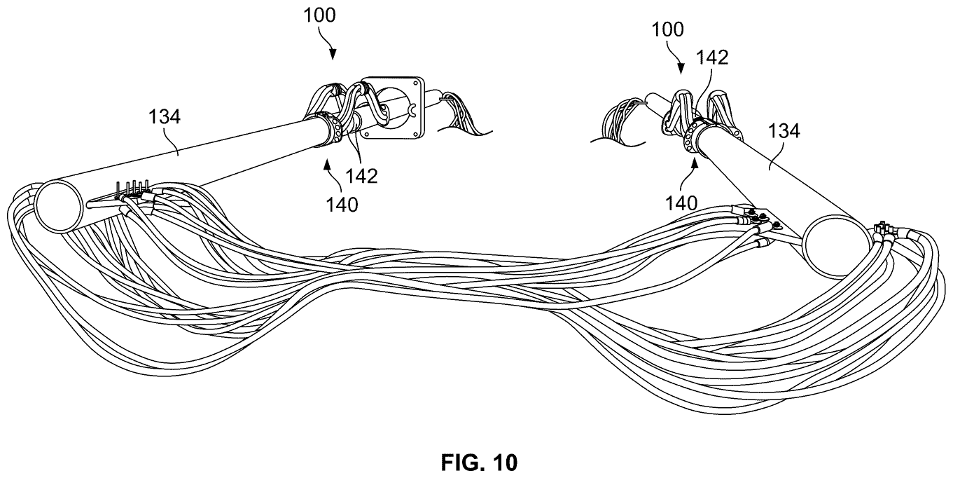

With this construction, as shown in FIG. 10, the shunt assembly 100 may be mounted to a tubular bus 134 and positioned to transfer current across a large, polished contact interface 140 between terminals 142 of the bus 134. Referring back to FIG. 6, the first coupler 102 includes raised, machined contact pads 144 defining an innermost perimeter 150 of the first coupler 102 sized to a diameter of the bus 134. As such the contact pads 144 engage low-resistance contact with the bus 134 with controlled contact pressure distribution. The first coupler 102 maintains surface finish quality along transmitting surfaces forming the contact interface 140 with the bus 134, reducing localized field intensification and supporting corona and RIV performance in operation.

With reference to FIGS. 7 and 9, the fasteners 124 seat in counterbores 152 and pull the first half 120 and the second half 122 together from complementary threaded surfaces 154, generating uniform hoop pressure around the bus 134 at the first coupler 102, rigidly stabilizing and fixing the first coupler 102 with the bus 134. The first halve and the second halve include close-tolerance features that align the apertures 160 equidistant from a clamp centerline 162 and manage current paths from the bus 134 into the plurality of conductors 112. The first halve and the second halve resist relative motion under thermal cycling and vibration, preserving geometry that evenly distributes current distribution and heat dissipation among the conductors 112.

As shown in FIG. 8, the first coupler 102 includes flanges 164 respectively extended outward from the first half 120 and the second half 122 in the lateral direction, forming a planar surface 170 extended straight in the lateral direction, and straight along the normal direction. With this construction, referring back to FIG. 7, the planar surface 170 at the flanges 164 presents a continuous, machined area across the first half 120 and the second half 122 in the normal direction, and aligns with the innermost perimeter 150 of the first coupler 102 in a circumferential direction orthogonal to the longitudinal direction. More specifically, the flanges 164 define the apertures 160 in single rows at opposite sides of the first coupler 102 in the lateral direction, where each of the rows extends along the planar surface 170 in the circumferential direction.

The first coupler 102 and the second coupler 104 include similar features and function in a similar manner with respect to fixing the conductors 112 with the bus 134, further description of which is omitted for the sake of brevity. In the depicted embodiment, the first coupler 102 and the second coupler 104 are a same model of sleeve clamp, such that the second coupler 104 includes the same features as the first coupler 102, mirrored across the conductors 112 in the longitudinal direction.

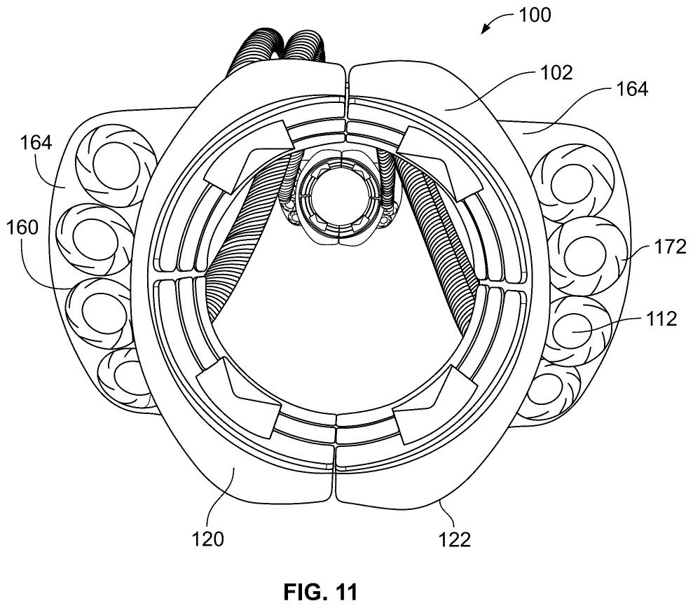

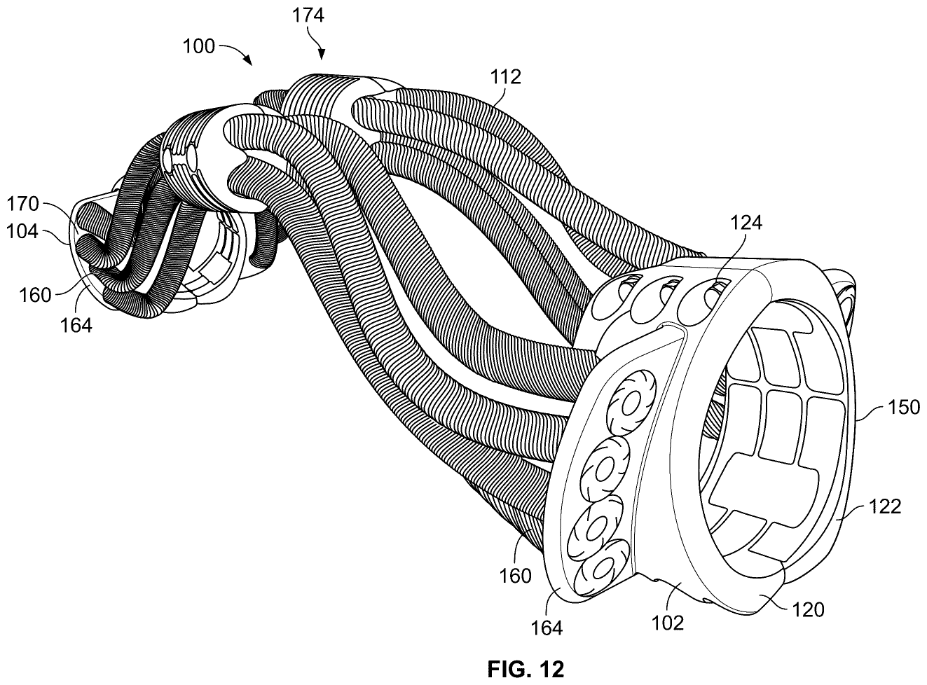

As shown in FIGS. 11 and 12, the conductors 112 are inserted and welded in the single rows of the apertures 160 along the flanges 164 with uniform offset from the innermost perimeter 150, forming balanced electrical path lengths from the bus 134, through the first coupler 102, to the conductors 112. The fasteners 124 in the first coupler 102 pull the first half 120 toward the second half 122 and maintain the single rows of the conductors 112 with the bus 134 under clamping load while aligning the apertures 160 equidistant from the innermost perimeter 150. With reference to FIG. 12, this geometry establishes a controlled transition from the single row at the first coupler 102 or the second coupler 104 into an arrangement 174 that is a matrix or a lattice pattern positioned between the first coupler 102 and the second coupler 104 through the radiators 114, as shown in the drawings. The sleeve clamp construction of the first coupler 102 and the second coupler 104 preserves the row alignment through thermal cycling and vibration to maintain current sharing among the conductors 112.

As shown in FIG. 3, the planar surface 170 sets an approach angle from the normal direction within a range that reduces bending disparities along the conductors 112, between the first coupler 102 and the second coupler 104 in the longitudinal direction. In embodiments, the range of angular offset between the planar surface 170 and the normal direction 8 - 28 degrees, minimizing an overall magnitude of deformation in the conductors 112 when the first coupler 102 and the second coupler 104 move relative to each other in the longitudinal direction.

With continued reference to FIG. 3, the conductors 112 are flexible as compared to the first coupler 102 and the second coupler 104. The conductors 112 each respectively include a first end portion 180 fixed with the first coupler 102, and include a second end portion 182 fixed with the second coupler 104. With this construction, the conductors 112 extends in the longitudinal direction between the first coupler 102 and the second coupler 104 and carries electrical current while the shunt assembly 100 flexes under mechanical loading. The conductors 112 elastically deforms during thermal expansion and contraction of the terminals 142 at the first coupler 102 and the second coupler 104, and maintains electrical continuity across movement of the first coupler 102, the second coupler 104, and the radiators 114 fixed with the conductors 112. In this manner, the conductors 112 extend and deform between the first coupler 102 and the second coupler 104 offset from each other in a longitudinal direction, maintaining electrical continuity through relative between the terminals 142.

The conductors 112 are formed from aluminum alloy stranded cables that increases flexibility and allows a small bending radius suitable for substation service. The conductors 112 match an aluminum alloy of the first coupler 102, the second coupler 104, and the radiators 114, promoting low-resistance current transfer and avoiding galvanic interaction at current-carrying interfaces through the shunt assembly 100.

The first end portions 180 of the conductors 112 are each fixed with the first coupler 102 along the planar surfaces 170 of the flanges 164 and seats in a single row of apertures 160 arranged circumferentially with uniform offset from an innermost perimeter 150 of the first coupler 102.

As shown in FIG. 11, welds 172 join strands at the first end portion 180 and anchor the first end portion 180 within the first coupler 102, establishing a large, polished contact interface 140 through raised, machined contact pads 144 that seat on a tubular bus 134. While, as depicted, the conductors 112 are welded with the first coupler 102 and the second coupler 104, the conductors 112 may additionally or alternatively be brazed, soldered, or mechanically fastened to the flange without departing from the scope of the present disclosure.

The first end portion 180 extends from the first coupler 102 at the approach angle defined by the planar surfaces 170, offset from the normal direction in a manner that reduces bending disparities and balances electrical path lengths toward the radiators 114 positioned between the first coupler 102 and the second coupler 104. In the depicted embodiment, the planar surface 170 is inclined from the normal direction 18 degrees. In alternative embodiments, the planar surface 170 may be inclined 8-28 degrees, angling the first end portions 180 of the conductors 112 toward the radiators 114 in an arch shape.

The second end portions 182 of the conductors 112 are fixed with the second coupler 104. More specifically, the second end portions 182 are inserted through apertures 160 defined in flanges 164, the apertures 160 being arranged in a single row, in the circumferential direction around the innermost perimeter 150 of the second coupler 104. In this manner, the flange aligns the second end portions 182 in a single row along the planar surfaces 170 at the second coupler 104. Fasteners 124 in the second coupler 104 maintain clamping load and sustain alignment through thermal cycling and vibration, preserving geometry that equalizes current distribution. In this regard, the second end portions 182 fixed with the second coupler 104 include similar features and function in a similar manner as the first end portions 180 fixed with the first coupler 102, further description of which is omitted for the sake of brevity. In the depicted embodiment, the conductors 112 are each symmetric in the longitudinal direction, such that corresponding pairs of the first end portions 180 and the second end portions 182 include the same features mirrored across a middle point of the conductors 112 in the longitudinal direction.

With continued reference to FIG. 3, the first end portions 180 and the second end portions 182 respectively form proximal arcuate segments and a distal arcuate segments. More specifically, the first end portions 180 each respectively form a first proximal arcuate segment 184 that opens in a first direction orthogonal to the longitudinal direction, and a first distal arcuate segment 190 that opens in a second direction opposite the first direction. The conductors 112 extend straight from the planar surface 170 at the flanges 164 into the first proximal arcuate segment 184, and then into the first distal arcuate segment 190. The first distal arcuate segments 190 each respectively extend into a middle portion 192 of the conductors 112, located at a middle point of the conductors 112 between the first coupler 102 and the second coupler 104 in the longitudinal direction. Bends along the conductors 112 forming the first proximal arcuate segments 184 and the first distal arcuate segments 190 position the middle portions 192 of the conductors 112 above the bus 134 in the normal direction, setting controlled entry paths that manage strain near the first coupler 102 and the second coupler 104, and balance the electrical path lengths toward the radiators 114 at the middle portions 192.

The first proximal arcuate segments 184 each respectively extend continuously into the first distal arcuate segment 190, forming an S-bend 194 in the first direction and the second direction with the distal arcuate segment along the conductors 112. The S-bend 194 formed from the first proximal arcuate segments 184 and the first distal arcuate segments 190 establishes a smooth curvature in the conductors 112 that limits localized bending radii ahead of the radiators 114 and reduces length inequality among adjacent conductors 112. As such, the S-bend 194 distributes deformation evenly during movement of the couplers, promoting uniform current sharing and temperature among the plurality of conductors 112.

The second end portion 182 forms a second proximal arcuate segment 200 and a second distal arcuate segment 202 along the conductors 112. The second proximal arcuate segment 200 opens in a third direction orthogonal to the longitudinal direction, and the second distal arcuate segment 202 opens in a fourth direction opposite the third direction. The pairs of proximal arcuate segments and corresponding distal arcuate segments formed from the first end portions 180 and the second end portions 182 mirror across the middle portion 192 in the longitudinal direction, aligning the S-bends 194 of the conductors 112 on each side of the radiators 114. This symmetry balances bending and path length from the first coupler 102 and the second coupler 104 toward a center of the shunt assembly 100 in the longitudinal direction and maintains alignment with the arrangement 174 through the radiators 114.

More specifically, and with continued reference to FIG. 3, the first distal arcuate segments 190 and the second distal arcuate segments 202 are interposed between and separate the first proximal arcuate segments 184 and the second proximal arcuate segments 200 along the conductors 112. The arcuate segments of the first end portions 180 and the second end portions 182 are oriented such that the first direction extends opposite the third direction along the longitudinal direction, and with the third direction along a normal direction orthogonal to the longitudinal direction. Also, the second direction extends opposite the fourth direction along the longitudinal direction, and with the fourth direction along the normal direction. With this construction, the first distal arcuate segments 190 and corresponding second distal arcuate segments 202 establish a central span in the middle portion 192 of the arched profile, and seat the radiators 114 in direct thermal contact with the conductors 112 along the central span. This also maintains straightness along the middle portion 192 at the radiators 114, and stabilizes geometry of the conductors 112 under thermal and mechanical loads, and preserves clearances to adjacent hardware in a substation environment.

The second proximal arcuate segments 200 and the second distal arcuate segments 202 respectively include similar features and function in a similar manner as the first proximal arcuate segments 184 and the first distal arcuate segments 190. In the depicted embodiment, the second proximal arcuate segments 200 and the second distal arcuate segments 202 respectively include same features mirrored from each other across the middle point of the conductors 112. With this construction, the shunt assembly 100 uniformly accommodates movement between the first coupler 102 and the second coupler 104 in the longitudinal direction.

The first coupler 102, the second coupler 104, and the radiators 114 are formed from a cast aluminum alloy. The conductors 112 are each formed an aluminum alloy complementary to the first coupler 102, the second coupler 104, and the radiators 114 for transferring electrical current and minimizing mechanical stresses in thermal cycling. Further, the conductors 112 are each respectively formed as a stranded cable having a complementary aluminum alloy helical wire arrangement at the proximal arcuate segment and the distal arcuate segment. In further embodiments, the conductors 112 may be formed as SAL aluminum alloy stranded cables constructed from seventy-eight helical strands, each of the strands having a diameter of about 4.07 mm, collectively defining a cross-sectional area of about 1180 mm², an overall conductor diameter of about 44.8 mm, and a weight of about 3193 kg/km. In such embodiments, the conductors 112 exhibit a direct current resistance of approximately 0.0271 Ω/km at 20° C. and a conductivity of about 36.3 m/Ω·mm² with a temperature coefficient of resistance of about 0.004 1/K, and sustains continuous operation at temperatures up to about 80° C. Taken as a whole, such embodiments provide high current transfer between the terminals 142 with low resistance while maintaining flexibility and durability suitable for the arched and S-bend geometries of the conductors 112.

With this construction, the conductors 112 are flexible as compared to the first coupler 102, the second coupler 104, and the radiators 114, and pass electrical current between the terminals 142. The conductors 112 may be made from various relatively flexible conductor types that deform between the first coupler 102 and the second coupler 104, and the elements of the shunt assembly 100 as a whole may be alternatively formed from copper or other similar metals or similar metal alloys without departing from the scope of the present disclosure.

The conductors 112 extend between and are fixed with the first coupler 102 and the second coupler 104, at the first end portion 180 the second end portion 182 fixed with the second coupler 104. The conductors 112 are fixed with the first coupler 102 and the second coupler 104 in single rows along the normal direction, and arranged in multiple rows offset from each other in the normal direction at a location between the first coupler 102 and the second coupler 104 in the longitudinal direction. The single row at each of the first coupler 102 and the second coupler 104 aligns in the circumferential direction with the apertures 160 along the planar surface 170 of the flanges 164, as described above, establishing equalized entry paths for the plurality of conductors 112 from the tubular bus 134 into the shunt assembly 100. The offset in the normal direction at the location between the first coupler 102 and the second coupler 104 organizes the plurality of conductors 112 into stacked rows that maintain compact spacing and equalize electrical path lengths toward the radiators 114.

The conductors 112 are arranged in the single rows of the apertures 160, in the circumferential direction with uniform radial offset from the innermost perimeter 150 of the first coupler 102 or the second coupler 104. The uniform radial offset between the conductors 112 and the innermost perimeter 150 around the tubular bus 134 supports balanced current distribution from the contact pads 144 into the plurality of conductors 112. Referring back to FIG. 3, the apertures 160 at the planar surface 170 seat the first end portions 180 and the second end portions 182 at radial positions equally distanced from the terminals 142 when fixed with the bus 134, preserving symmetry about the clamp centerline 162 in the lateral direction.

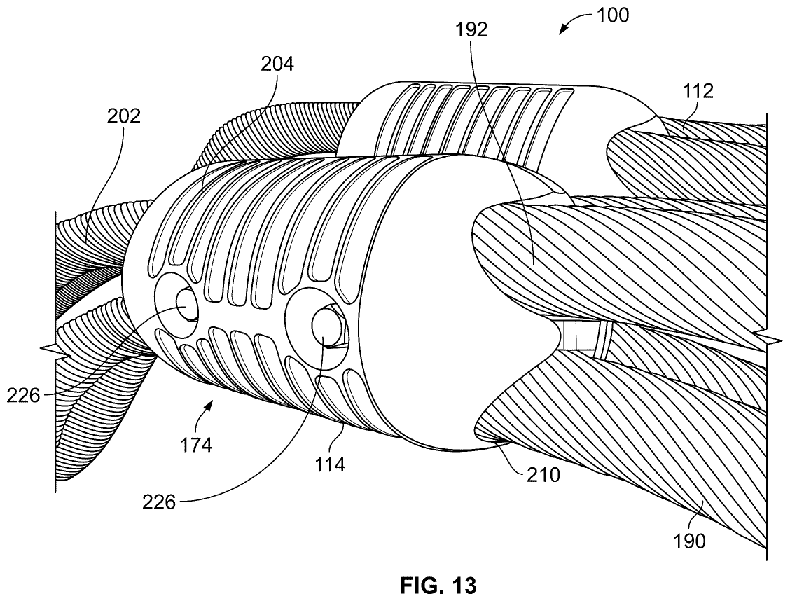

The conductors 112 are arranged single file at the first coupler 102 or the second coupler 104 along an inner perimeter of the first coupler 102 or the second coupler 104, and arranged in the arrangement 174 through the radiators 114 between the first coupler 102 and the second coupler 104, the arrangement 174 extending in the lateral direction and the normal direction. As shown in FIG. 13, the arrangement 174 includes multiple rows of the conductors 112 offset from each other in the normal direction, and multiple columns of the conductors 112 offset in the lateral direction, forming a compact, generally rectangular pattern on each side of a middle portion 192 of the arched profile. More specifically, the arrangement 174 includes a square two by two matrix at each of the radiators 114.

The arrangement 174 spans a width across the lateral direction that aligns the conductors 112 with mounting features of the radiators 114 and stabilizes the spacing between adjacent conductors 112 under thermal and mechanical loads. As described above, the arrangement 174 locating the conductors 112 in multiple rows offset from each other in the normal direction occurs at the location between the first coupler 102 and the second coupler 104 and coincides with the radiators 114. The radiators 114 hold the plurality of conductors 112 at the arrangement 174 through close-tolerance passages 210 that guide the transition from the single row at the first coupler 102 and the second coupler 104 into the stacked rows, reducing bending disparities in the conductors 112 ahead of the radiators 114, managing proximity effects among adjacent conductors 112, and balancing current sharing across the plurality of conductors 112 during operation.

In embodiments, the plurality of the conductors 112 includes at least four and no more than twelve conductors 112 fixed with the first coupler 102 and the second coupler 104. In the depicted embodiment, as shown in FIG. 5, the first half 120 and the second half 122 of the first coupler 102 are each fixed with four of the conductors 112, and the first half 120 and the second half 122 of the second coupler 104 are each fixed with four conductors 112, such that each coupler is fixed with a total of eight conductors 112. The count of eight conductors 112 arranged along the circumferential direction balances current sharing across the plurality of the conductors 112 and limits temperature rise at the sleeve clamps and the radiators 114, promoting uniform current distribution and enhanced heat dissipation along the shunt assembly 100.

The radiators 114 are rigid as compared to the conductors 112, and fixed with the conductors 112 along the arched profile, between the first coupler 102 and the second coupler 104 in the longitudinal direction. Referring back to FIG. 13, each of the radiators 114 respectively includes fins 204 that extend outward from the conductors 112 in a radial direction orthogonal to the circumferential direction, where the fins 204 radiate heat conducted through the radiators 114 from the conductors 112.

The radiators 114 are each formed from a cast aluminum body with precision machined passages 210 that receive the conductors 112 at the middle portion 192, along the arched profile. The cast aluminum body of the radiators 114 provides increased thermal mass and exposes surface area through the fins 204, promoting heat dissipation along the normal direction and the lateral direction. The machined passages 210 align the conductors 112 in the arrangement 174 described above and stabilize spacing under thermal and mechanical loads, supporting uniform current distribution and limiting localized hot spots in the shunt assembly 100 during operation.

As shown in FIG. 3, the radiators 114 are fixed in direct thermal contact with the conductors 112, along the conductors 112 between the first coupler 102 and the second coupler 104, at a side of the distal arcuate segments 190, 202 opposite the proximal arcuate segments 184, 200. With this construction, the radiators 114 are centered on the middle portion 192 between the first distal arcuate segment 190 and the second distal arcuate segment 202 in the longitudinal direction.

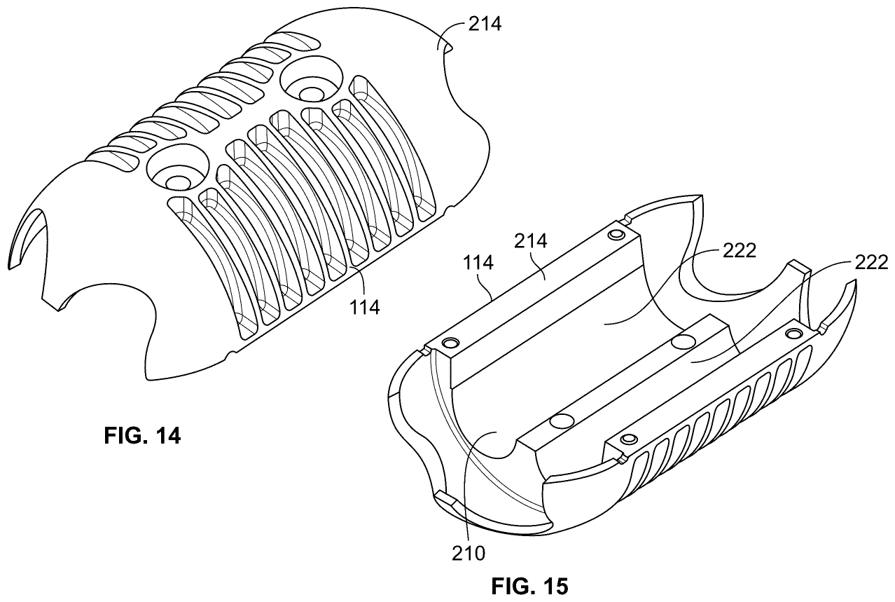

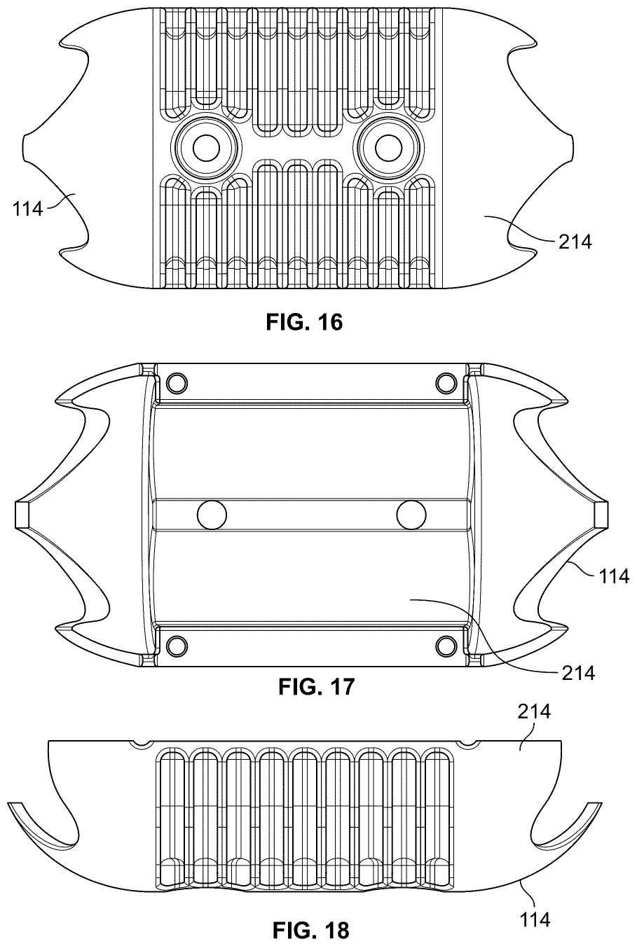

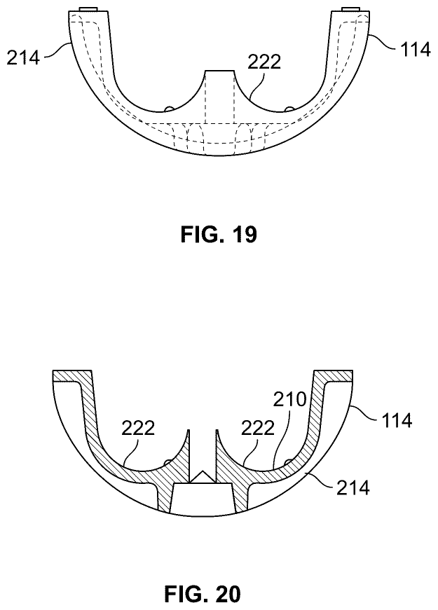

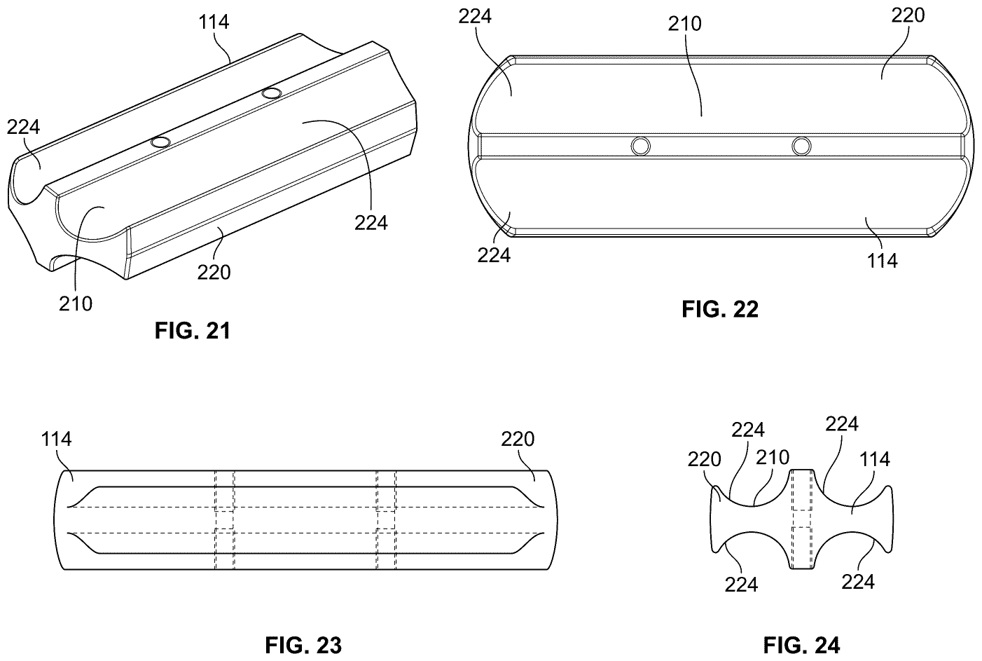

FIG. 14-24 depict portions of the radiators 114, where FIG. 14-20 depict a shell 212, including a first shell portion 214, and FIG. 21-24 depict an insert 220 included in the radiators 114. The direct thermal contact between the radiators 114 and the conductors 112 occurs at smooth, matched shell surfaces 222 depicted in FIG. 15, and smooth, matched insert surfaces 224 depicted in FIG. 21. The shell surfaces 222 and the insert surfaces 224 form the passages 210 in the radiators 114, sized to a diameter of the conductors 112 with an interference fit that maximizes conductive heat transfer. As such, the welds 172 at the first end portion 180 and the second end portion 182 anchor the conductors 112 with the first coupler 102 and the second coupler 104, while mechanical fasteners 226 (see FIG. 13) and interference engagement fix the conductors 112 within the radiators 114 at the middle portion 192, maintaining straightness in the conductors 112 through the radiators 114 and preserving clearances to adjacent substation hardware, including adjacent conductors 112. The mechanical fasteners 226 are bolts that engage threaded surfaces of the insert 220 through the shell 212, fixing the shell 212 with the insert 220. With the conductors 112 mechanically fastened within the radiators 114, the radiators 114 may be assembled or disassembled with the conductors 112 by hand in the field, reducing initial setup and ongoing maintenance times.

As shown in FIG. 5, the shell 212 includes a second shell portion 230. The second shell portion 230 includes similar features and functions in a similar manner as the first shell portion 214. In view of this, further description is omitted for the sake of brevity. In the depicted embodiment, the second shell portion 230 includes same features as the first shell portion 214, mirrored across the conductors 112 in the lateral direction. The first shell portion 214 and the second shell portion 230 receive the fasteners 226 that engage the insert 220, and respectively retain the first shell portion 214 and the second shell portion 230 with the insert 220, locking the radiators 114 with the conductors 112 in the passages 210, at the middle portion 192. In this regard, as shown in FIG. 21-24, the insert 220 includes complementary threaded surfaces 154 that engage the fasteners 124 from opposite sides of the insert 220 in the lateral direction.

Referring back to FIG. 13, the radiators 114 balance currents among the conductors 112 by tying the plurality of the conductors 112 at the middle portion 192, reducing disparities between the conductors 112 caused by skin effect and proximity effect. The cast aluminum body of the radiators 114 maintains material continuity with the first coupler 102, the second coupler 104, and the conductors 112, promoting low-resistance current transfer across interfaces and avoiding galvanic interaction. In the depicted embodiment, the radiators 114, including the fins 204, span a width in the lateral direction that matches the arrangement 174 of the plurality of conductors 112, holding the stacked rows in place through close-tolerance guidance and resisting relative motion under vibration and thermal cycling.

With reference to FIG. 3, the first end portion 180 and the second end portion 182 respectively form a first leg 240 and a second leg 242 in the arched profile of the conductors 112, the first leg 240 and the second leg 242 extending along the normal direction and the lateral direction. The radiators 114 are fixed to the conductors 112 at the middle portion 192, along the arched profile between the first leg 240 and the second leg 242 in the longitudinal direction. At the middle portion 192, the passages 210 in the radiators 114 defined by the shell 212 and the insert 220 receive the plurality of conductors 112 in the arrangement 174 described above and hold spacing that aligns the first leg 240 and the second leg 242 on opposite sides of the radiators 114.

The radiators 114 span the lateral direction between the first leg 240 and the second leg 242, tying the plurality of conductors 112 at the middle portion 192 and stabilizing geometry under thermal and mechanical loads. This placement centers thermal mass and an area of the fins 224 at the middle portion 192 and supports balanced current sharing by equalizing path length from the first coupler 102 and the second coupler 104 into the radiators 114.

The middle portion 192 extends straight in the longitudinal direction between the first end portion 180 and the second end portion 182, and presents continuous seating surfaces for direct thermal contact between the shell surfaces 222 and the insert surfaces 224, and an outer strand layer of each of the conductors 112. The straight span along the middle portion 192 guides the transition from the first leg 240 and the second leg 242 into the arrangement 174 through the radiators 114, maintaining equalized length of the conductors 112 across adjacent positions, and preserving clearances to adjacent substation hardware. The straight geometry at the middle portion 192 also reduces local bending ahead of the radiators 114, promotes uniform contact pressure within the passages 210, and enhances conductive heat transfer through the radiator fins 204.

As shown in FIG. 5, the radiators 114 include a first radiator 232 and a second radiator 234 offset from the first radiator 232 in the lateral direction. The first radiator 232 holds the conductors 112 fixed with the first half 120 of the first coupler 102 and a first half 244 of the second coupler 104, and the second radiator 234 holds the conductors 112 fixed with the second half 122 of the first coupler 102 and a second half 250 of the second coupler 104. The first half 244 of the second coupler 104 and the second half 250 of the second coupler 104 respectively include similar features and function in a similar manner as the first half 120 of the first coupler 102 and the second half 122 of the first coupler 102, further description of which is omitted for the sake of brevity.

The arrangement of the first radiator 232 and the second radiator 234 respectively aligns the first radiator 232 with the first half 120 of the first coupler 102 and the first half 120 of the second coupler 104, and aligns the second radiator 234 with the second half 122 of the first coupler 102 and the second half 122 of the second coupler 104. In this manner, the arrangement of the first radiator 232 and the second radiator 234 preserves symmetry about the clamp centerline 162 in the lateral direction, and ties the stacked rows of the conductors 112 at the middle portion 192. The offset between the first radiator 232 and the second radiator 234 in the lateral direction spaces the plurality of conductors 112 on opposite sides of the shunt assembly 100, reduces proximity effects between columns in the arrangement 174 through the radiators 114, and enhances heat dissipation across the fins 204.

The first radiator 232 receives the plurality of conductors 112 that the first half 120 of the first coupler 102 and the first half 120 of the second coupler 104 retain. The second radiator 234 mirrors the first radiator 232 across the plurality of conductors 112 in the lateral direction. The second radiator 234 receives the plurality of conductors 112 that the second half 122 of the first coupler 102 and the second half 122 of the second coupler 104 retain, and fixes the conductors 112 at the middle portion 192 with direct thermal contact along the passages 210. The cast aluminum body and fins 204 of the radiators 114 provide thermal mass and exposed area that dissipate heat, while the passages 210 hold the stacked rows and columns of the arrangement 174 to resist relative motion under vibration and thermal cycling. The symmetry between the first radiator 232 and the second radiator 234 in the lateral direction aligns the first leg 240 and the second leg 242 of the arched profile on opposite sides of the radiators 114 and preserves equalized electrical path lengths across the plurality of conductors 112.

As a pair, the first radiator 232 and the second radiator 234 maintain the arrangement 174 on each side of the middle portion 192 in the longitudinal direction, and reduce bending disparities ahead of the radiators 114 in the longitudinal direction. The two-radiator architecture avoids conductor crowding above the tubular bus 134, improves current balance by tying each side independently, and limits temperature differences among adjacent conductors 112, as discussed above.

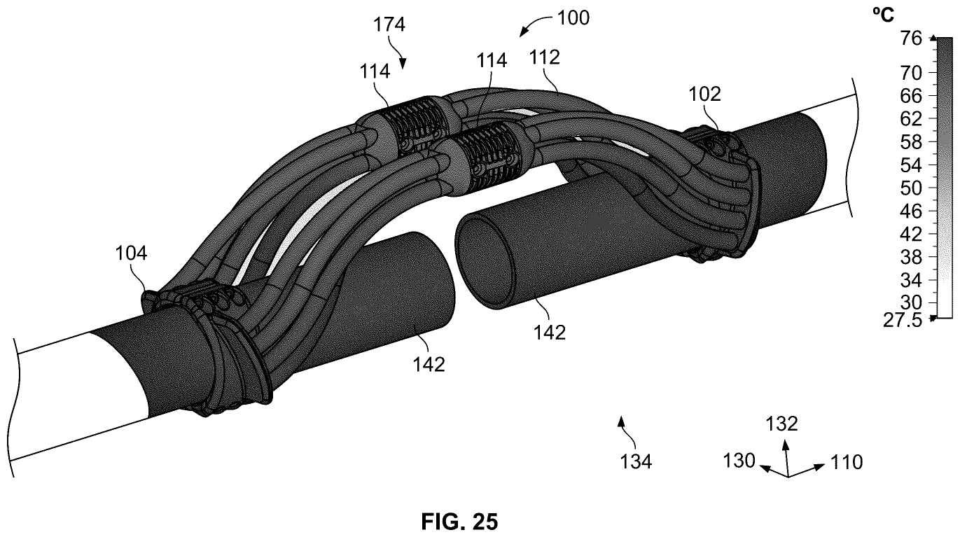

FIG. 25 is a heat map of an embodiment of the shunt assembly 100 in operation. The heat map of FIG. 25 depicts temperature distribution along the plurality of conductors 112 and the radiators 114 during current transfer between the first coupler 102 and the second coupler 104 on the terminals 142. As shown, the temperature of the conductors 112 is balanced across the arrangement 174, where resistive heat is collected and dissipated from the radiators 114 through the fins 204. In this manner, the two-radiator architecture of the shunt assembly 100 equalizes current sharing among adjacent conductors 112, limits localized hot spots, and maintains temperatures of the conductors within a continuous operating range.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited thereto.

Further, the term “in” as used to describe an object with respect to a given direction (e.g., an edge extended in a left-right direction) is intended to denote an orientation that is substantially parallel to the specified direction. In contrast, the term “along” as used to describe an object with respect to a given direction (e.g., an edge extended along a vertical direction) is intended to indicate that a feature or element possesses a common vector component in that direction, even if its overall alignment is not strictly parallel.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A shunt assembly, comprising:
a first coupler and a second coupler offset from each other in a longitudinal direction; and
a conductor that is flexible as compared to the first coupler and the second coupler, includes a first end portion fixed with the first coupler, and includes a second end portion fixed with the second coupler,
wherein the first end portion or the second end portion forms a proximal arcuate segment and a distal arcuate segment, the proximal arcuate segment opens in a first direction orthogonal to the longitudinal direction, and the distal arcuate segment opens in a second direction opposite the first direction.

2. The shunt assembly of claim 1, wherein the proximal arcuate segment extends continuously into the distal arcuate segment, forming an S-bend in the first direction with the distal arcuate segment along the conductor.

3. The shunt assembly of claim 1, wherein the first end portion forms the proximal arcuate segment as a first proximal arcuate segment, and forms the distal arcuate segment as a first distal arcuate segment, and
the second end portion forms a second proximal arcuate segment and a second distal arcuate segment along the conductor, the second proximal arcuate segment opens in a third direction orthogonal to the longitudinal direction, and the second distal arcuate segment opens in a fourth direction opposite the third direction.

4. The shunt assembly of claim 3, wherein the first distal arcuate segment and the second distal arcuate segment are interposed between and separate the first proximal arcuate segment and the second proximal arcuate segment along the conductor, and
the first direction extends opposite the third direction along the longitudinal direction, and with the third direction along a normal direction orthogonal to the longitudinal direction, and
the second direction extends opposite the fourth direction along the longitudinal direction, and with the fourth direction along the normal direction.

5. The shunt assembly of claim 1, wherein the conductor is a stranded cable with helical wire arrangement at the proximal arcuate segment and the distal arcuate segment, and each of the first coupler, the second coupler, and the conductor are formed from an aluminum alloy.

6. The shunt assembly of claim 1, further comprising a radiator fixed in direct thermal contact with the conductor, along the conductor between the first coupler and the second coupler, at a side of the distal arcuate segment opposite the proximal arcuate segment and one of the first coupler and the second coupler, wherein the radiator is rigid as compared to the conductor, and includes fins that extend outward from the conductor.

7. The shunt assembly of claim 1, further comprising a plurality of conductors including the conductor, wherein each of the conductors respectively includes a first end portion fixed with the first coupler, and includes a second end portion fixed with the second coupler,
wherein each of the conductors are fixed with the first coupler or the second coupler in a single row along a normal direction orthogonal to the longitudinal direction, and
arranged in multiple rows offset from each other in the normal direction, at a location between first coupler and the second coupler in the longitudinal direction.

8. The shunt assembly of claim 1 further comprising a plurality of conductors including the conductor, wherein each of the conductors respectively includes a first end portion fixed with the first coupler, and includes a second end portion fixed with the second coupler,
wherein the plurality of conductors includes at least four and no more than twelve conductors fixed with the first coupler and the second coupler.

9. The shunt assembly of claim 1 further comprising a plurality of conductors including the conductor, wherein each of the conductors respectively includes a first end portion fixed with the first coupler, and includes a second end portion fixed with the second couple,
wherein the first coupler or the second coupler is a sleeve clamp, the conductors arranged in a single row, in a circumferential direction orthogonal to the longitudinal direction, with uniform offset from an innermost perimeter of the first coupler or the second coupler.

10. The shunt assembly of claim 1, further comprising a plurality of conductors including the conductor, wherein each of the conductors respectively includes a first end portion fixed with a planar surface of the first coupler, wherein the planar surface extends straight in a lateral direction orthogonal to the longitudinal direction, extends straight along a normal direction orthogonal to the longitudinal direction and the lateral direction, and is angled 8 - 28 degrees from the normal direction.

11. A shunt assembly, comprising:
a first coupler and a second coupler offset from each other in a longitudinal direction;
a conductor that is flexible as compared to the first coupler and the second coupler, includes a first end portion fixed with the first coupler, includes a second end portion fixed with the second coupler, and forms an arched profile in the first end portion and the second end portion, along the longitudinal direction; and
a radiator that is rigid as compared to the conductor, fixed with the conductor along the arched profile, between the first coupler and the second coupler in the longitudinal direction, and includes fins that extend outward from the conductor.

12. The shunt assembly of claim 11, wherein the first end portion and the second end portion respectively form a first leg and a second leg in the arched profile, the first leg and the second leg extending along a normal direction and a lateral direction orthogonal to the longitudinal direction, and
the radiator is fixed along a middle portion of the arched profile, between the first leg and the second leg along the conductor.

13. The shunt assembly of claim 12, wherein the first end portion includes a first proximal arcuate segment and a first distal arcuate segment that opens in a direction opposite the first proximal arcuate segment and orthogonal to the longitudinal direction, or
the second end portion includes a second proximal arcuate segment and a second distal arcuate segment that opens in a direction opposite the second proximal arcuate segment and orthogonal to the longitudinal direction.

14. The shunt assembly of claim 12, wherein the middle portion extends straight in the longitudinal direction between the first end portion and the second end portion.

15. The shunt assembly of claim 11, plurality of conductors between the first coupler and the second coupler, are arranged single file at the first coupler or the second coupler, along an inner perimeter of the first coupler or the second coupler, and arranged in a matrix through the radiator between the first coupler and the second coupler.

16. A shunt assembly, comprising:
a first coupler and a second coupler offset from each other in a longitudinal direction; and
a plurality of conductors extending between the first coupler and the second coupler, each of the conductors including a first end portion fixed with the first coupler and a second end portion fixed with the second coupler,
wherein each of the conductors are fixed with the first coupler or the second coupler in a single row along a normal direction orthogonal to the longitudinal direction, and
the conductors are arranged in multiple rows offset from each other in the normal direction, at a location between first coupler and the second coupler in the longitudinal direction.

17. The shunt assembly of claim 16, wherein the first coupler and the second coupler are sleeve clamps, each of the sleeve clamps include a first half fixed with a second half in a lateral direction orthogonal to the longitudinal direction and the normal direction, the first half and the second half each retaining a portion of the plurality of conductors.

18. The shunt assembly of claim 17, wherein the first coupler or the second coupler includes a flange forming a planar surface extended straight in the lateral direction, and straight along the normal direction, and
the conductors are fixed with the first coupler or the second coupler in a single row along the flange.

19. The shunt assembly of claim 18, further comprising a radiator fixed with the conductors between the first coupler and the second coupler in the longitudinal direction,
wherein the conductors are welded, brazed, or soldered to the flange, and mechanically fastened to the radiator.

20. The shunt assembly of claim 17, further comprising a first radiator and a second radiator offset from the first radiator in the lateral direction,
wherein the first radiator holds the conductors fixed with the first half of the first coupler and the first half of the second coupler,
the second radiator holds the conductors fixed with the second half of the first coupler and the second half of the second coupler, and
the first radiator and the second radiator are fixed along the conductor at a middle portion of an arched profile formed from the first end portions and the second end portions.
